(19) United States
(12) Patent Application Publication
(10) Pub. No.: US 2014/0279186 A1
(43) Pub. Date: Sep. 18, 2014

(54) DIGITAL WARDROBE WITH RECOMMENDER SYSTEM

(71) Applicant: YAHOO! INC., Sunnyvale, CA (US)

(72) Inventors: Wen-Hsiang Juan, Taipei (TW); Chun-I Tsai, Taipei (TW); San-Ching Yu, Taipei (TW)

(21) Appl. No.: 13/799,462

(22) Filed: Mar. 13, 2013

(51) Int. Cl. G06Q 30/06

(52) U.S. Cl. CPC G06Q 30/0631
USPC 705/26.7

(57) ABSTRACT

Wearable objects purchased by a user are added to a digital wardrobe associated with the user. The user can create and store various outfits from the contents of the digital wardrobe. A recommender system also accesses the digital wardrobe and provides recommendations of wearable items personalized to the user's tastes.

### BACKGROUND

The development of Internet not only lead to the age of information but also heralded the development of eCommerce which facilitates purchase of goods without having to visit the brick and mortar store of a vendor. Various goods are sold online of which electronics, books, music, appliances, home furnishings, office supplies are usually purchased by consumers via websites. In addition, consumers also purchase many accessories and apparel online.

### SUMMARY

This disclosure facilitates a user to store wearable items such as garments or accessories in a digital wardrobe, create outfits from combinations of the wearable items in the digital wardrobe and store the created outfits in the digital wardrobe. A recommender system that has access to the digital wardrobe is enabled to provide recommendations of wearable items to be purchased based on the contents of the digital wardrobe.

A processor executable method for providing recommendations is disclosed in accordance with an embodiment. The method comprises steps executed by the processor that include receiving information regarding a first wearable item purchased by a user, adding the first wearable item to a digital wardrobe of the user, providing access to the digital wardrobe upon request from the user, facilitating creation of at least one combination outfit of the first wearable item with other wearable items by the user and storing a finalized combination outfit in the digital wardrobe, recommending additional wearable items not included in the digital wardrobe for purchase by the user. In an embodiment, the method further comprises facilitating, by the processor, changes to an outfit by the user, wherein the outfit is stored in the user's digital wardrobe and comprises at least two items from the digital wardrobe.

In an embodiment, facilitating creation of the combination outfit further comprises processor executable steps of providing images of the first wearable item and other wearable items to the user, receiving user selection of the first wearable item and at least one of the other wearable items, receiving input indicating user intention to create the finalized combination outfit from the first wearable item and at least one of the other wearable item and storing data related to the first wearable item and the at least one other wearable item as the combination outfit in the digital wardrobe. In an embodiment, the other wearable items are contents of the digital wardrobe. In an embodiment, the other wearable items are contents of a wish list associated with the user. In an embodiment, the contents of the digital wardrobe are purchased online. In an embodiment, the contents of the digital wardrobe are purchased at a physical store. In an embodiment, recommending additional wearable items further comprises the processor executable steps of receiving metadata of the additional wearable items, determining that the additional wearable items have metadata that matches metadata of contents of the digital wardrobe.

In an embodiment, recommending additional wearable items further comprises, the processor executable steps of: generating a suggested combination outfit comprising a wearable item from the digital wardrobe and at least one of the additional wearable items, providing an image of a suggested combination outfit created from contents of the digital wardrobe and at least one of the additional wearable items to the user.

A computing device comprising a processor and a storage medium for tangibly storing thereon program logic for execution by the processor is disclosed in an embodiment. The program logic comprises purchase item receiving logic to receive information regarding a first wearable object purchased by a user, adding logic to add the first wearable item to a digital wardrobe of the user, access providing logic to provide access to the digital wardrobe upon request from the user, outfit creation facilitating logic to facilitate creation of at least one combination outfit of the first wearable object with other wearable objects by the user, outfit storing logic to store a finalized combination outfit in the digital wardrobe and recommending logic to recommend additional wearable objects not included in the digital wardrobe for purchase by the user. In an embodiment, the outfit creation facilitating logic further comprises, image providing logic that provides images of the first wearable object and other wearable objects to the user, user selection receiving logic that receives user selection of the first wearable object and at least one of the other wearable objects, user input receiving logic for receiving user input indicating that the finalized combination outfit has been created. In an embodiment, the recommending logic further comprises, additional item receiving logic for receiving metadata of the additional wearable items and match determining logic for determining that the additional wearable items have metadata that matches metadata of contents of the digital wardrobe.

A computer readable storage medium comprising processor executable instructions is disclosed in an embodiment. The instructions when executed by a processor cause the processor to receive information regarding a first wearable item purchased by a user, add the first wearable item to a digital wardrobe of the user, provide access to the digital wardrobe upon request from the user, facilitate creation of at least one combination outfit of the first wearable item with other wearable items by the user, store a finalized combination outfit in the digital wardrobe and recommend additional wearable items not included in the digital wardrobe for purchase by the user. In an embodiment, the storage medium further comprises instructions to provide images of the first wearable item and other wearable items to the user, receive user selection of the first wearable item and at least one of the other wearable items, receive input indicating user intention to create the finalized combination outfit from the first wearable item and at least one of the other wearable item and store data related to the first wearable item and the at least one other wearable item as the combination outfit in the digital wardrobe. In an embodiment, the computer readable medium further comprising instructions which when executed by a processor, cause the processor to receive metadata of the additional wearable items and determine that the additional wearable items have metadata that matches metadata of contents of the digital wardrobe.

These and other embodiments/will be apparent to those of ordinary skill in the art with reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 illustrates a system for storing a digital wardrobe and providing recommendations of items to purchase in accordance with an embodiment;

FIG. 2 illustrates some modules further comprised within the digital wardrobe module in accordance with an embodiment;

FIG. 3A is a schematic diagram of a user interface that permits creating and editing a digital wardrobe in accordance with one embodiment;

FIG. 3B illustrates parts of the user interface displayed based on the size/type of the display screen in accordance with an embodiment;

FIG. 4 is a schematic diagram that shows the details of a recommender module in accordance with an embodiment;

FIG. 5 shows a flowchart detailing a method of storing user generated outfits in accordance with an embodiment;

FIG. 6 shows a flowchart that details a method of providing personalized recommendations of wearable items to users in accordance with an embodiment;

FIG. 7 illustrates internal architecture of a computing device in accordance with embodiments described herein; and

FIG. 8 is a schematic diagram illustrating a client device implementation of a computing device in accordance with embodiments of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions or logic can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The advent of the Internet and subsequent development of eCommerce websites has led users to be able to shop for any desired item round the clock on any given day of the week. Accordingly, some online retailers have grown larger than some brick and mortar shops. In fact, in some categories of goods, such as, electronics or content such as ebooks, music, movies etc. online vendors can provide instant wish fulfillment to users. With the advent of better imaging technologies and increasing bandwidth availability via various networks consumers are also purchasing wearable items like clothing, jewelry, shoes or other accessories online via eCommerce websites. Regardless of how a consumer purchases a wearable item like clothing or other accessory, in order to determine how the item fits him/her, the consumer needs to try on the wearable item physically. In order to determine the combinations of items that would look good when worn together, the consumer needs to try on the various clothing or accessories together. This can be very time consuming if the right combination cannot be determined quickly. Moreover, when a consumer is in a physical store or purchasing a clothing item online, the consumer may not be able to determine accurately if the clothing item he/she is planning to purchase suits a garment that he/she already possesses since he/she may not have access to the garment at the time of purchase. In this situation it can be helpful if consumers have online access to a collection of digital versions corresponding to wearable items such as clothing or accessories that they may have in their wardrobes.

Embodiments disclosed herein relate to creating and accessing a digital wardrobe with a recommender system. In an embodiment, a collection of digital images of items purchased online via an eCommerce website can be stored in the user's account which can be accessed using a client device from any location via the Internet or a cellular network. Users can virtually try out various combinations of items in their digital wardrobe from a remote location at their leisure thereby saving them the time and effort of having to physically try out the wearable items in their real-world wardrobes. Moreover, if vendors also have access to the users' digital wardrobes it will enable them to recommend appropriate items that are personalized to each consumer's tastes based on the items in the consumer's wardrobe. Accordingly, embodiments are also included herein that pair a recommender system to the digital wardrobe which facilitates personalizing item recommendations for the users.

Turning now to FIG. 1, a system for storing a digital wardrobe and providing recommendations of item to purchase based on the information from the digital wardrobe is shown. In one embodiment, the digital wardrobe and recommender system 100 can be associated with an online retailer running an eCommerce website 110 hosted on a server 1000 communicatively coupled to a network 1002. The website 110 is configured to facilitate browsing and online purchase transactions of users for various items including wearable items such as clothing and accessories. The eCommerce website 110 can be accessed via a mobile or tethered client device 150, using for example, a user interface 1004 such as a browser software or a mobile ‘app’. In addition to facilitating browsing and purchasing activities of users, the eCommerce website also has associated therewith, a digital wardrobe that is accessible to the users of the website. In an embodiment, each user has a unique digital wardrobe 130 assigned to his or her user account. The digital wardrobe 130 comprises a collection of one or more of images and metadata associated with items selected by the user. In an embodiment, the digital wardrobe 130 comprise separate shelves (or sections) that include wearable items actually purchased by the user and items that a user selects for perusal and likely future purchase. The digital wardrobe 130 can be accessed at any time using the client device 150 via the website 110 to facilitate the user to generate and store outfits from separate items in the wardrobe 130 as will be described further herein. The website 110 also comprises a recommender module 108 that recommends items for purchase to the user based on the items in the user's wardrobe 130.

In an embodiment, the digital wardrobe and recommender system 100 comprises an item receiving module 102, a digital wardrobe module 104, and a recommender module 108. When a user purchases a wearable item from the website 110, the item receiving module 102 receives information regarding the purchased items in addition to the user information. The item receiving module 102 is also configured to receive information regarding items that the user can select for closer perusal and possible future purchase, such as, when an item is added to the user's wish list. The item receiving module 102 also receives information related to outfits generated from contents of the user's wardrobe that the user would like to save, edit or delete.

The information thus obtained by the item receiving module 102 is communicated to the digital wardrobe module 104. Based on the obtained information, the digital wardrobe module 104 is configured to execute various functions. The digital wardrobe module 104 comprises a plurality of digital wardrobes 132 each of which is associated with one of the users of the website 110. It may be appreciated that although the digital wardrobes 132 are shown as being part of the digital wardrobe module 104, it is not necessary and that the digital wardrobes 132 may be stored in a separate module either on server 1000 or on another disparate server that is communicatively coupled to the server 1000. In an embodiment, each digital wardrobe 134 assigned to a unique user can comprise a shelf or section 1342 for purchased items, a section 1344 for items in the user's wish list and a section for stored outfits 1346. Whenever the user associated with the digital wardrobe 134 purchases a wearable item from the website 110, or adds a wearable item to the wish list 1344, its information such as its metadata including style, color, size, description, a unique item code associated with that particular item are stored in the digital wardrobe 134. Similarly, when the user of the digital wardrobe 134 creates an outfit and saves it, the information is stored in the outfits section 1346. The digital wardrobe 134 or information therein can stored, for example, on a server 1000 that is hosting the website 110 or another sever (not shown) communicatively couple to the website 110. This facilitates the user to access the digital wardrobe 134 at any time and from any location using a client device 150 by logging into his/her user account associated with the website 110.

In an embodiment, the wearable items purchased in a physical store associated with the eCommerce website 110 (or any other physical store or website whose goods are marked to be compatible with the digital wardrobe and recommender system 100) can also be added to users' digital wardrobes 132. For example, when items are scanned at the store check out during a purchase transaction, the purchasing user's account identification information associated with the eCommerce website 110 can also be collected. The user identification information along with the unique identification metadata of the purchased wearable items can be received by the item receiving module 102 and the purchased wearable items can be accordingly added to the user's respective digital wardrobe by the digital wardrobe module 104.

FIG. 2 is a detailed illustration 200 of some modules further comprised within the digital wardrobe module 104. An item creating module 202 is included in the digital wardrobe module 104 to create outfits or add items to the plurality of digital wardrobes 132. The information received by the item receiving module 102 is accessed by the item creating module 202 that determines the item to be added, the digital wardrobe in which the wearable item is to be added and the section or shelf of the digital wardrobe in which the item needs to be included. The information regarding the digital wardrobe in which a received item is to be added is obtained from the user account information transmitted with the wearable item. As discussed previously, each user of the website 110 has a unique digital wardrobe assigned to the user account which stores items purchased or desired to be purchased by the user. For example, based on the user account information and a user input, it may be determined that a received wearable item is to be added to the wish list section 1344 of the digital wardrobe 134. Similarly, if a user desires to save an outfit made from multiple items of the purchased section 1342 and/or the wish list 1344, the item creation module 202 can store such information associated with each other indicating that the multiple wearable items make up the outfit.

The digital wardrobe module 104 also permits users to further edit or modify previously created and stored outfits via the item editing/modification module 204. Thus, the individual wearable items that are associated with a given outfit may be further modified in an embodiment. In an embodiment, the item editing module 204 facilitates adding another item to an existing outfit and storing the modified outfit either in place of the previously stored outfit or as a new outfit. Similarly, the item editing module 204 facilitates users to delete particular wearable items associated with an outfit and store it in place of the previous version of the outfit or as a new outfit. In an embodiment, the item editing module 204 can also permit users to completely delete an outfit.

In an embodiment, users can associate specific data with a user-generated outfits. For example, the user associated with the digital wardrobe 134 can generate five outfits from the wearable items included in the digital wardrobe and assign dates to each of the five items indicating the day/date on which the outfit is to be worn. Similarly, users can also define their own metadata to particular outfits or even particular wearable items in their wardrobes, for example, naming the outfits, such as “Monday meeting outfit”, or “Friday casual outfit” etc.

An item communication module 206 is included in the digital wardrobe module 104 to facilitate providing communications regarding particular outfits associated with each of the digital wardrobes 132. Notifications regarding changes or deletions made to a digital wardrobe 134 can be communicated to the user of the digital wardrobe 134. In an embodiment, communications regarding the user's planned outfits can be sent to user-specified destinations. For example, the user can opt to receive daily communications such as emails, with an image of the outfit and/or details regarding the wearable items that make up the outfit planned by the user for that day. This mitigates the need for the user to log into his/her account with the website 110 routinely in order to determine the outfit that is planned for that day. In an embodiment, the item communication module 206 is also configured to receive recommended items from the item recommender module 106 and forward the information to the user as will be detailed further herein.

FIG. 3A is a schematic diagram of a user interface 300 that permits creating and editing a digital wardrobe in accordance with one embodiment. It may be appreciated that the user interface 300 is shown only by the way of illustration and not limitation and that other user interfaces can be employed with the embodiments of a digital wardrobe and recommender system 100 described herein. In an embodiment, the user interface 300 can be built with browser executable mark up language. The user interface 300 includes a work area or an outfit creation area 320 and a digital wardrobe area 340 that displays images of items in a particular digital wardrobe 134. In an embodiment, the work area 320 can be further divided into sections that correspond to parts of a human body. Thus, the headgear section 322 corresponds to the head, section 324 to the torso, section 326 to the legs while section 328 corresponds to the feet of a person. Similarly, the wardrobe area 340 is divided into various sections that show wearable objects corresponding to the sections in the work area 320. Thus, section 342 shows hats included in the digital wardrobe 134, section 344 shows objects/items that can be worn on the torso of a person such as shirts, sweaters or other tops, section 346 shows wearable objects such as pants, skits, leggings or other bottoms, and section 348 shows shoes included in the digital wardrobe 134. In an embodiment, each of the sections 342, 344, 346, and 348 are further divided to show the items in the wardrobe and items in the user's wish list. Therefore section 342 can be divided into 3422 and 3424 to display wearable items purchased by the user in the user's digital wardrobe 3422 and items that the user selects for closer perusal and possible purchase at a later time in the wish list 3424. Similarly, each of the sections 344, 346, and 348 are further divided to the respective wardrobe shelves/sections 3442, 3462, 3482 and respective wish lists 3444, 3446, 3486. Including wish lists 3424, 3444, 3446 and 3448 facilitates the user of the wardrobe 134 to determine how a particular wearable item matches other items in the wardrobe 134 prior to purchasing it by including the wearable item in the appropriate wish list 3424, 3444, 3446 and 3448 and creating outfits from the item in the wish list with items in the wardrobe 134.

The user interface 300 also includes a ‘your outfits’ section 350 for displaying various outfits generated and stored by the user. Again it may be appreciated that the placement of the outfits section 350 is only by the way of illustration and not limitation and that it can be placed anywhere in the user interface 300.

If a user desires to build an outfit from the wearable items in the digital wardrobe 134, the user can select one of the wardrobe section or wish list section corresponding to each of the wearable items shelf/sections 342, 344, 346, and 348. For example, in FIG. 3A, the user is generating an outfit from items that are worn on the torso and the legs. Accordingly, the items selected from sections 344 and 346 are displayed in areas 324 and 326. Any of the items in the wardrobe 3442, 3462 or the wish lists 3444, 3464 can be selected to build the outfits. In an embodiment, when the user desires to build the outfit from a section, the section can be selected 352 and items from the selected section can be reviewed serially via the arrows 362 and 364. As there is only one item in the wish list, the user selects the top from the wish list section 3444. The bottom selected by the user is shown in area 326. It can be seen via the highlight 354 that the user selected the skirt 370 from the wardrobe 3462. The user can employ the arrows 366, 368 to serially browse through the items in the wardrobe section and arrive at the desired item 370. When the user is satisfied with the combination, the save button 380 can be clicked to store the outfit from items 372 and 370 in the digital wardrobe 134 which will be added and displayed to the user in the ‘your outfits’ section 350.

The ‘your outfits’ section 350 shows the user generated outfits. Various outfits can be generated by the users by combining items in the wardrobes 3442, 3462, 3482 and/or wish lists 3444, 3446, 3486. When an outfit includes an item that is yet to be purchased from a wish list, the item can be highlighted 352 within the section 350. When the item is removed from the wish list by the user without purchasing it, the digital wardrobe module 104 can be configured to automatically modify the outfit by removing the item. If the item is purchased by the user, the highlighting 356 can be removed indicating that the user now owns the item. In an embodiment, the ‘your outfits’ section 350 also facilitates users to modify outfits via, for example, context menu 358 which can include for example, ‘edit’ and ‘delete’ options. It may be appreciated that only two menu options are shown for brevity and that other options can also be included.

FIG. 3B shows a user interface based on the display screen size in which only selected parts of the user interface 300 are displayed. For example, for a smartphone with display screen size between approximately three to five inches in length one of the work area 320 or sections 342, 344, 346, 348 or 350 may be displayed at a time in an embodiment.

FIG. 4 is a schematic diagram that shows the details of a recommender module 106 in accordance with an embodiment. The recommender module 106 includes a recommendation item receiving module 402, a recommendation matching module 404 and a recommendation providing module 406. The recommendation item receiving module 402 is enabled to access wearable items associated with the inventory of the website 110. In an embodiment, the recommendation item receiving module 402 accesses existing inventory so that items from existing inventory can be recommended to each new user as they sign up or open new accounts with the website 110. The recommendation items receiving module 402 also receives information regarding new items as they are added to the inventory and facilitates providing fresh recommendations to existing users of the website 110.

The recommendation matching module 404 receives the wearable items information from the recommendation items receiving module 402 and matches metadata associated with the received wearable items from the inventory with the metadata of items currently included in each of the digital wardrobes 132 of the users, and provides personalized recommendations to each user based on matching metadata. The recommendations matching module 404 will therefore not only be configured to access item metadata but will also be configured to access user information in order to be able to provide such user-specific recommendations. For example, the recommendation matching module 404 can match for example, style, color, size, type of garment/accessory or combinations thereof to provide recommendations that are specific to a user's wardrobe. As the digital wardrobes 132 include items that are already purchased or are desired to be purchased by the users, there is greater likelihood of the recommendations being relevant or compatible with each user's individual preferences. Thus, the recommendation matching module 404 provides more personalized recommendations as compared to the generic view-also-view or buy-also-buy recommendations usually provided by existing eCommerce systems.

The metadata of matched wearable items along with the user information is communicated to the recommendations providing module 406. In an embodiment, the recommendations providing module 406 can generate an outfit from the matched recommended items and provide the outfit information to the user associated with the recommendation. Therefore, the recommender module 108 is configured to suggest outfits that are built from wearable items in the inventory of the website 110 with items from each user's digital wardrobe 132. In a further embodiment, the recommendations providing module 406 can generate an image of the recommended outfit and provide it to the user so that the user can see how a recommended item matches a particular wearable item in his/her wardrobe. The recommender module 106 thus not only educates users regarding the latest fashions but also helps to gradually update their wardrobes to keep up with emerging trends.

FIG. 5 shows a flowchart 500 detailing a method of storing user generated outfits in accordance with an embodiment. The method begins at 502 with the website 110 receiving a request from the user associated with the digital wardrobe 134 for access to the items in the digital wardrobe 134. The items comprised within the digital wardrobe 134 including those in the wardrobe as well as wish lists are transmitted for display to the user at 504. At 506 input is received indicating that the user would like to save an outfit comprising at least two items in the digital wardrobe 134. The metadata associated with the user selected items is stored together as an outfit under the user's digital wardrobe 134 as shown at 508. As discussed supra, in an embodiment, the digital wardrobe 134 can be a collection of metadata such as images, description, tags or other user generated information associated with various wearable items either purchased or selected for prospective purchases by a user. Therefore, when the user indicates a desire to save an outfit in the digital wardrobe 134, the metadata associated with the wearable items making up the outfit is paired and stored together with a unique id. In an embodiment, the unique id can be user generated, for example the user can name particular outfits, or it can be generated automatically by the digital wardrobe module 104 in case the user does not supply a unique id. The digital wardrobe 134 can be stored on a non-transitory processor executable storage medium and may be accessed from remote locations by authentication methods that are generally used for accessing user-specific data.

FIG. 6 shows a flowchart 600 that details a method of providing personalized recommendations of wearable items to users. The method begins at 602 wherein the recommender module 108 receives items to recommend. For example, as new items are added to the inventory of the website 110, information associated with the new items can be transmitted to the recommender module 108 in order to identify the users to whom the newly added items may be recommended for purchasing. The various items in each of the digital wardrobes 132 associated with the various users are accessed at 604. For example, the recommender module 108 accesses the metadata of the various items in the digital wardrobes 132. At 606, it is determined if the metadata of the newly added items matches the metadata of the items in the digital wardrobes 132. The wearable items whose metadata matches items of each of the digital wardrobes 132 are recommended to respective users at 608. For example, the newly added items whose metadata matches those of the items in the digital wardrobe 134 are recommended to the user associated with the digital wardrobe 134. In an embodiment, the items may be recommended by sending images to the users. In an embodiment, the newly wearable items may have metadata associated therewith that indicate the wearable items from the digital wardrobes 132 that they are likely to match. For example, apparel with similar style as those in the users digital wardrobes can be recommended to respective users. Thus, an outfit comprising a newly added wearable item(s) and one or more items in the digital wardrobes can also be suggested to respective users. The digital wardrobe and recommender system 100 as described in its various embodiments thus not only engages users thus making them adhesive to the website 110 but also enhances sales of the wearable items in the website 110.

As shown in the example of FIG. 7, internal architecture of a computing device 700 includes one or more processing units (also referred to herein as CPUs) 712, which interface with at least one computer bus 702. Also interfacing with computer bus 702 are persistent storage medium/media 706, network interface 714, memory 704, e.g., random access memory (RAM), run-time transient memory, read only memory (ROM), etc., media disk drive interface 708, an interface 720 for a drive that can read and/or write to media including removable media such as floppy, CD-ROM, DVD, etc., media, display interface 710 as interface for a monitor or other display device, keyboard interface 716 as interface for a keyboard, pointing device interface 718 as an interface for a mouse or other pointing device, and miscellaneous other interfaces 722 not shown individually, such as parallel and serial port interfaces, a universal serial bus (USB) interface, and the like.

Memory 704 interfaces with computer bus 702 so as to provide information stored in memory 704 to CPU 712 during execution of software programs such as an operating system, application programs, device drivers, and software modules that comprise program code or logic, and/or computer-executable process steps, incorporating functionality described herein, e.g., one or more of process flows described herein. CPU 712 first loads computer-executable process steps or logic from storage, e.g., memory 704, storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage medium/media 706 is a computer readable storage medium(s) that can be used to store software and data, e.g., an operating system and one or more application programs. Persistent storage medium/media 706 can also be used to store device drivers, such as one or more of a digital camera driver, monitor driver, printer driver, scanner driver, or other device drivers, web pages, content files, metadata, playlists and other files. Persistent storage medium/media 706 can further include program modules and data files used to implement one or more embodiments of the present disclosure.

FIG. 8 is a schematic diagram illustrating a client device implementation of a computing device in accordance with embodiments of the present disclosure. A client device 800 may include a computing device capable of sending or receiving signals, such as via a wired or a wireless network, and capable of running application software or “apps”. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. The client device can include standard components such as a CPU 802, power supply 828, a memory 818, ROM 820, BIOS 822, network interface(s) 830, audio interface 832, display 834, keypad 836, illuminator 838, I/O interface 840 interconnected via circuitry 826. Claimed subject matter is intended to cover a wide range of potential variations. For example, the keypad 836 of a cell phone may include a numeric keypad or a display 834 of limited functionality, such as a monochrome liquid crystal display (LCD) for displaying text. In contrast, however, as another example, a web-enabled client device 800 may include one or more physical or virtual keyboards 836, mass storage, one or more accelerometers, one or more gyroscopes, global positioning system (GPS) 824 or other location identifying type capability, Haptic interface 842, or a display with a high degree of functionality, such as a touch-sensitive color 2D or 3D display, for example. The memory 818 can include Random Access Memory 804 including an area for data storage 808.

A client device 800 may include or may execute a variety of operating systems 806, including a personal computer operating system, such as a Windows, iOS or Linux, or a mobile operating system, such as iOS, Android, or Windows Mobile, or the like. A client device 800 may include or may execute a variety of possible applications 810, such as a client software application 814 enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A client device 800 may also include or execute an application to communicate content, such as, for example, textual content, multimedia content, or the like. A client device 800 may also include or execute an application 812 to perform a variety of possible tasks, such as browsing, searching, playing various forms of content, including locally stored or streamed content, such as, video, or games (such as fantasy sports leagues). The foregoing is provided to illustrate that claimed subject matter is intended to include a wide range of possible features or capabilities.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
receiving, by a processor, information regarding a first wearable item purchased by a user;
adding, by the processor, the first wearable item to a digital wardrobe of the user;
providing, by the processor, access to the digital wardrobe upon request from the user;
facilitating, by the processor, creation of at least one combination outfit of the first wearable item with other wearable items by the user;
storing, by the processor, a finalized combination outfit in the digital wardrobe;
recommending, by the processor, additional wearable items not included in the digital wardrobe for purchase by the user.

2. The method of claim 1, facilitating creation of the combination outfit further comprises:
providing, by the processor, images of the first wearable item and other wearable items to the user;
receiving, by the processor, user selection of the first wearable item and at least one of the other wearable items;
receiving, by the processor, input indicating user intention to create the finalized combination outfit from the first wearable item and at least one of the other wearable item; and
storing, by the processor, data related to the first wearable item and the at least one other wearable item as the combination outfit in the digital wardrobe.

3. The method of claim 1 wherein other wearable items are contents of the digital wardrobe.

4. The method of claim 1, wherein other wearable items are contents of a wish list associated with the user.

5. The method of claim 1, wherein contents of the digital wardrobe are purchased online.

6. The method of claim 1, wherein the contents of the digital wardrobe are purchased in at a physical store.

7. The method of claim 1, recommending additional wearable items further comprises:
receiving, by the processor, metadata of the additional wearable items;
determining, by the processor, that the additional wearable items have metadata that matches metadata of contents of the digital wardrobe.

8. The method of claim 1, recommending additional wearable items further comprising:
generating, by the processor, a suggested combination outfit comprising a wearable item from the digital wardrobe and at least one of the additional wearable items;

9. The method of claim 8, further comprising:
providing, by the processor, an image of a suggested combination outfit created from contents of the digital wardrobe and at least one of the additional wearable items to the user.

10. The method of claim 1, further comprising:
facilitating, by the processor, changes to an outfit by the user, wherein the outfit is stored in the user's digital wardrobe and comprises at least two items from the digital wardrobe.

11. A computing device comprising:
a processor;
a storage medium for tangibly storing thereon program logic for execution by the processor, the program logic comprising:
purchase item receiving logic, executed by the processor, to receive information regarding a first wearable object purchased by a user;
adding logic, executed by the processor, to add the first wearable item to a digital wardrobe of the user;
access providing logic, executed by the processor, to provide access to the digital wardrobe upon request from the user;
outfit creation facilitating logic, executed by the processor, to facilitate creation of at least one combination outfit of the first wearable object with other wearable objects by the user;
outfit storing logic, executed by the processor, to store a finalized combination outfit in the digital wardrobe;
recommending logic, executed by the processor, to recommend additional wearable objects not included in the digital wardrobe for purchase by the user.

12. The computing device of claim 11, wherein the outfit creation facilitating logic further comprises:
image providing logic, executed by the processor, to provide images of the first wearable object and other wearable objects to the user;
user selection receiving logic, executed by the processor, to receive user selection of the first wearable object and at least one of the other wearable objects;
user input receiving logic, executed by the processor, for receiving input from the user indicating that creation of the finalized combination outfit is completed.

13. The computing device of claim 11 wherein other wearable objects are contents of the digital wardrobe.

14. The computing device of claim 11, wherein other wearable objects are contents of a wish list associated with the user.

15. The computing device of claim 11, the recommending logic further comprises:
additional item receiving logic, executed by the processor, for receiving metadata of the additional wearable items;
match determining logic, executed by the processor, for determining that the additional wearable items have metadata that matches metadata of contents of the digital wardrobe.

16. A computer readable storage medium, comprising instructions, which when executed by a processor cause the processor to:
receive information regarding a first wearable item purchased by a user;
add the first wearable item to a digital wardrobe of the user;
provide access to the digital wardrobe upon request from the user;
facilitate creation of at least one combination outfit of the first wearable item with other wearable items by the user;
store a finalized combination outfit in the digital wardrobe;
recommend additional wearable items not included in the digital wardrobe for purchase by the user.

17. The computer readable medium of claim 16, further comprising instructions which when executed by a processor, cause the processor to:
provide images of the first wearable item and other wearable items to the user;
receive user selection of the first wearable item and at least one of the other wearable items;
receive input indicating user intention to create the finalized combination outfit from the first wearable item and at least one of the other wearable item; and
store data related to the first wearable item and the at least one other wearable item as the combination outfit in the digital wardrobe.

18. The computer readable medium of claim 16 wherein other wearable items are contents of the digital wardrobe.

19. The computer readable medium of claim 16 wherein other wearable items are contents of a wish list associated with the user.

20. The computer readable medium of claim 16, further comprising instructions which when executed by a processor, cause the processor to:
receive metadata of the additional wearable items;
determine that the additional wearable items have metadata that matches metadata of contents of the digital wardrobe.
